(19) United States
(12) Patent Application Publication
(10) Pub. No.: US 2007/0170720 A1
(43) Pub. Date: Jul. 26, 2007

(54) Tuning cable to pressure body connector

(76) Inventors: James Beatty, Marysville, MI (US); Frank Zawodny, Lapeer, MI (US)

Correspondence Address: DYKEMA GOSSETT PLLC, Suite 300, 39577 Woodward Avenue, Bloomfield Hills, MI, 48304, US

(21) Appl. No.: 11/338,993

(22) Filed: Jan. 25, 2006

(51) Int. Cl. F16L 33/00

(52) U.S. Cl. 285/256

(57) ABSTRACT

A fluid assembly is provided having a fluid connector for coupling a fluid conduit and a tuning cable to form a fluid tight, pressurized connection for energy attenuation. The connector includes two end portions defining ports and an intermediate portion defining a fluid passageway extending between the two ports. One of the end portions includes an end form over which the tuning cable is disposed. A fluid conduit is received over the other end portion and an inturned lip of the conduit is deflected outward and rides a conically tapered section until it is received within a groove defined in the intermediate portion between the tapered section and a radially outwardly extending flange.

### TECHNICAL FIELD

This invention relates to a fluid assembly having a fluid connector for coupling a fluid conduit and a tuning cable to form a fluid tight, pressurized connection for energy attenuation.

### BACKGROUND OF THE INVENTION

Motor vehicles may include various fluid handling systems, such as, but not limited to, fuel systems, power steering systems, heating and cooling systems, and hydraulic braking systems. These fluid handling systems may require the attachment of various tubular bodies, connectors and other components to create robust seals and fluid tight, pressurized joints for fluid handling.

Many different fluid system components, including hoses, cables and other fluid conduits are used within a fluid assembly to optimize the fluid flow and operation of the system. Different structures methods are known in the art to couple together the fluid components of an assembly, including the use of connectors or adapters. Conventional coupling structures and methods for coupling tuning cables and fluid conduits in a fluid assembly, however, frequently require a crimping operation the secure the tuning cable, connector and fluid conduit, increasing assembly time and cost. Further, conventional coupling structures and methods often fail to provide a reliable fluid seal—particularly for systems involved in the transport of highly pressurized fluids.

The inventors herein have recognized a need for a fluid assembly and method for assembling a fluid assembly that will minimize and/or eliminate one or more of the above-identified deficiencies.

### SUMMARY OF THE INVENTION

The present invention relates to a fluid assembly including an apparatus for coupling components of a fluid assembly, as well as a method of assembling a fluid assembly.

More particularly, the present invention provides a connector for coupling a fluid conduit and a tuning cable within a fluid assembly. The connector includes a first end portion which defines a first port. The connector further includes a second end portion which defines a second port and having an end form in which the tuning cable may be disposed. The connector further includes an intermediate portion disposed between the first and second end portions. The first and second end portions and the intermediate portion together define a fluid passageway extending from the first port to the second port. The intermediate portion further includes a radially outwardly extending flange and a conically tapered section disposed between the flange and the first end portion. The tapered section has an outer diameter that decreases moving from a first point intermediate the flange and the first end portion to a second point where the intermediate portion and the first end portion intersect. The intermediate portion further includes a groove that is provided between the flange and the first point of the tapered section. The groove is configured to receive an inwardly projecting lip of the fluid conduit after radial deflection of the lip upon insertion of the connector in the fluid conduit.

A method of assembling a fluid assembly in accordance with the present invention includes the step of providing a connector as previously described hereinabove. The method also includes the step of inserting the first end portion of the connector into a first end of a fluid conduit. The method also includes the step of inserting the second end portion of the connector into a first end of a tuning cable such that the tuning cable is disposed over the end form on the second end portion of the connector. The end of the fluid conduit defines a radially inwardly extending lip that deflects outwardly as the tapered section of the intermediate portion of the connector is inserted into the fluid conduit and that is received in the groove of the intermediate portion after passing the first point of the intermediate portion of the connector.

A fluid assembly and method of assembling a fluid assembly n accordance with the present invention have significant advantages relative to the conventional coupling devices used for fluid system components. The fluid assembly and method of assembly provide an improved fluid seal between while providing a more efficient connection of the tuning cable and fluid conduit.

These and other advantages of this invention will become apparent to one skilled in the art from the following detailed description and the accompanying drawings illustrating features of this invention by way of example.

### BRIEF DESCRIPTION OF THE DRAWINGS

The present invention will now be described by way of example, with reference to the accompanying drawings:

FIG. 1 is a diagrammatic plan view of a fluid system incorporating a fluid assembly in accordance with the present invention.

FIG. 2 is a cross-sectional view of a fluid assembly in accordance with one embodiment of the present invention;

FIG. 3 is an cross sectional view of one component of the fluid assembly shown in FIG. 2.; and

FIG. 4 is a flow chart illustrating a method of assembling a fluid assembly in accordance with the present invention.

### DETAILED DESCRIPTION OF THE PREFERRED EMBODIMENT

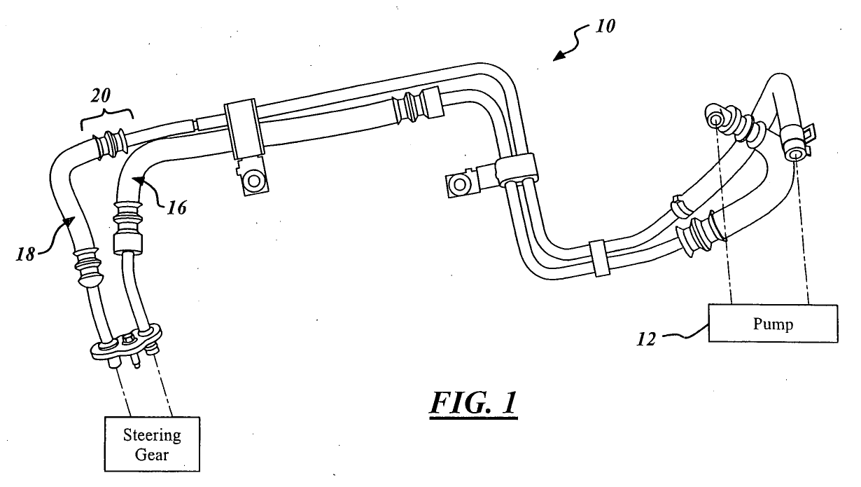

Referring now to the drawings wherein like reference numerals are used to identify identical components in the various views, FIG. 1 illustrates an exemplary fluid system 10 incorporating a pump 12, steering gear 14, and hose assemblies 16, 18, at least one of which includes a fluid assembly 20 in accordance with the present invention. The illustrated fluid system 10 comprises a power steering system for a vehicle. It should be understood, however, that the present invention may find application in a variety of fluid systems in both vehicular (e.g., fuel systems, heating/cooling systems, etc.) and non-vehicular applications.

Pump 12 is provided to produce fluid flow to provide the force required for operation of gear 14. Pump 12 is conventional in the art and may be driven responsive to rotation of an engine crankshaft (not shown) or other power output member of the engine. Pump 12 may comprise any of a variety of conventional pumps including roller pumps, vane pumps, slipper pumps and gear pumps.

Steering gear 14 is provided to convert rotary motion from a steering wheel (not shown) into linear motion to move a steering linkage (not shown) coupled to one or more wheels (not shown). Gear 14 is also conventional in the art and may comprise any of a variety of conventional steering gears including recirculating ball gears, worm and roller gears and rack and pinion steering gears.

Hose assemblies 16, 18 are provided to transmit fluid between pump 12 and steering gear 14 and are disposed between pump 12 and gear 14. Hose assembly 16 supplies pressurized fluid from pump 12 to steering gear 14 while hose assembly 18 returns fluid from steering gear to a reservoir of pump 12. Hose assemblies 16, 18 may comprise a plurality of sections of metal tubing and reinforced synthetic rubber crimped together and/or overlaid at connection points.

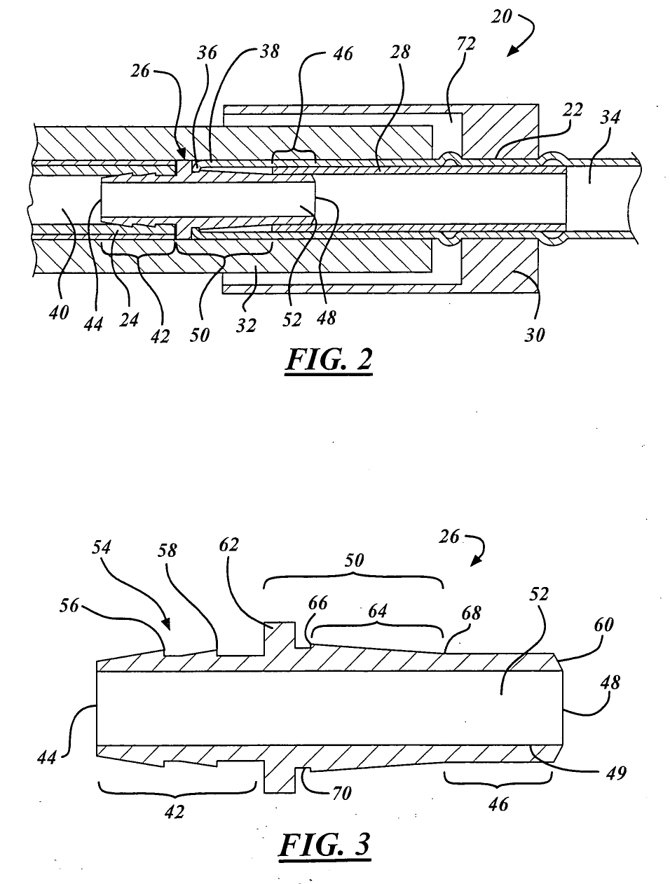

Referring now to FIG. 2, a fluid assembly 20 in accordance with the present invention is described and illustrated. Assembly 20 may include a fluid conduit 22, a tuning cable 24 and a connector 26. Assembly 20 may further include a tubular insert 28, a crimp collar 30, and a hose 32.

Fluid conduit 22 defines a fluid passageway 34 having a radially inwardly projecting lip 36 at one end 38 of conduit 22 for a purpose described hereinbelow. Fluid conduit 22 is generally cylindrical in shape and is made from conventional metals, metal alloys or combinations thereof.

Tuning cable 24 is provided to attenuate fluid pressure pulses in a pressurized fluid assembly. Tuning cable 24 may be provided at a predetermined length for providing the proper attenuation of fluid pressure pulses. Tuning cable 24 further provides a fluid passageway 40 for allowing continued transmission of fluid throughout the fluid assembly 10. Tuning cable 18 may comprise flexible wound steel or a polymer. Modified tuning cables can be used in various fluid assemblies depending on the noise attenuation needs of the systems. Accordingly, various tuning cables may be used in the present invention.

Connector 26, as can be seen in FIGS. 2 and 3, may be provided for coupling fluid conduit 22 and tuning cable 24. Connector 26 includes an end portions 42, 46 defining a port 44 and another end portion 46 defining another port 48. An intermediate portion 50 is further disposed between end portions 42, 46. End portions 42, 46 and intermediate portion 50 together define a constant diameter fluid passageway 52 extending from port 44 to port 48. Connector 26 may comprise various metals, metal alloys, or combinations thereof. In particular, connector 26 may comprise a combination copper and zinc therein forming a brass connector. Connector 26 may further comprise other materials including polymers, depending on the type of fluid used within the fluid assembly.

End portion 42 of connector 26 is configured for being engagingly received by tuning cable 24. End portion 42 further provides an end form 54 over which tuning cable 24 is disposed upon the coupling of connector 26 with tuning cable 24. End form 54 may include at least one barb, a bead, or any other type of outwardly projecting form that would engage tuning cable 24 and provide a secured engagement between end portion 42 of connector 26 and tuning cable 24. In the illustrated embodiment, end form 54 includes two barbs 56, 58. The diameter of each barb 56, 58 increases moving in a direction away from port 44 defining outer ramp surfaces that rise at angles of about seven and fifteen degrees, respectively. A portion of end portion 42 between barbs 56, 58 and between barb 58 and intermediate portion 50 have substantially constant diameters.

End portion 46 of connector 26 is configured to be received within fluid conduit 22. End portion 46 is further provided with a beveled edge 60 at one end and at least section 47 of end portion 46 has a constant diameter for a purpose described hereinbelow.

Intermediate portion 50 defines a radially outwardly extending flange 62 defining opposed faces against which ends of fluid conduit 22 and tuning cable 24 are disposed upon assembly of fluid assembly 20. Portion 50 further defines conically tapered section 64 disposed between flange 62 and end portion 46 of connector 26. Tapered section 64 includes an outer diameter that decreases when moving from a first point 66 intermediate flange 62 and end portion 46 to a second point 68 at which intermediate portion 50 and end portion 46 intersect. Accordingly, tapered section 64 is cylindrically tapered in a downward direction move towards end portion 46 and provides a surface that causes radial deflection of lip 36 of fluid conduit 22 upon insertion of connector 26 in fluid conduit 22. Portion 50 further defines a groove 70 between flange 62 and point 66 on tapered section 64. Groove 70 is configured to receive the inwardly projecting lip 36 at end 38 of fluid conduit 22. In particular, groove 70 reflects the size and shape of inwardly projecting lip 36 in order to readily receive lip 36 for secure engagement. The snap-fit engagement of lip 36 into groove 70 after lip 36 passes point 66 of tapered section 64 ensure the secured coupling of fluid conduit 22 with connector 26. Furthermore, lip 36 is disposed against flange 62 further preventing fluid conduit 22 from moving out of groove 70 and disrupting the provided engagement of conduit 22 and connector 26.

Tubular insert 28 improves the fluid seal between conduit 22 and connector 26. Insert 28 is disposed within fluid conduit in fluid passageway 22 inwardly from lip 36 and end 38 of conduit 22. Insert 28 may be configured in various lengths and diameters depending on the design of the fluid system. Tubular insert 28 may be comprised of various metals, metal alloys and combinations of both. Preferably, tubular insert 28 is comprised of steel: Upon insertion of connector 26 within fluid conduit 22, beveled edge 60 of end portion 46 facilitates insertion of end portion 46 within insert 28. As shown in FIG. 2, end portion 46 of connector 26 is slidably received by tubular insert 28 as provided within fluid conduit 22 to form a fluid tight seal between the fluid components. End portion 46 and tubular insert 28 are engaged in an interference fit between the components.

Crimp collar 30 is provided to secure hose 32 to fluid conduit 22. Collar 30 is disposed about conduit 22 remote from end 38 of conduit 22 and defines an annular recess 72 that is closed at one end. Recess 72 is configured to receive one end of hose 32. After receipt of hose 32, collar 30 may be deformed to secure the connection between hose 32 and conduit 22.

Hose 32 is provided for transporting fluids within fluid system 10. Hose 32 is conventional in the art and may be made of rubber or polymeric materials. Upon assembly of hose 32 with the other components of fluid assembly 10, tuning cable 24 extends into hose 32 for a predetermined length to attenuate fluid pulses in system 10.

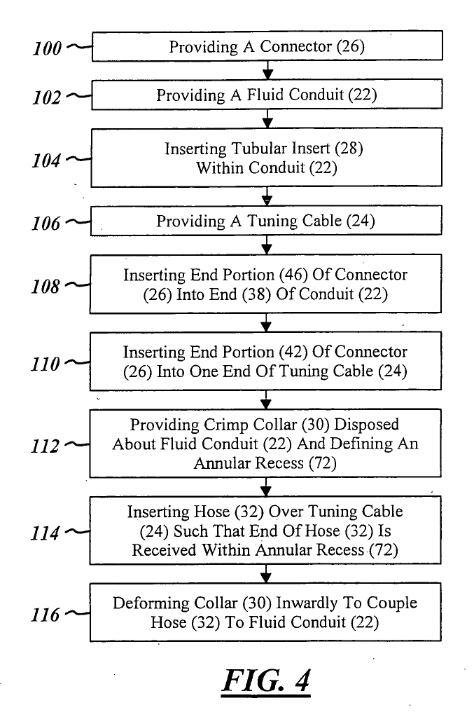

Referring now to FIG. 4, a method of assembling a fluid assembly in accordance with the present invention is described. The inventive method may begin with the step 100 of providing a connector, such as connector 26, having end portions 42, 46 and an intermediate portion 50 as described hereinabove. The method may continue with the step 102 of providing another component, such as fluid conduit 22 that defines an inwardly projecting lip 36 at one end 38 and may further include the step 104 of inserting a tubular insert 28 within conduit 22. The method may further continue with the step 106 of providing another component, such as tuning cable 24. The inventive method may continue with the step 108 of inserting end portion 46 into end 38 of conduit 22. As end portion 46 is inserted, lip 36 of conduit 22 is deflected radially outwardly by the tapered section 64 of intermediate portion 50 of connector 26. Connector 26 is inserted until lip 36 passes point 66 on tapered section 64 at which point lip 36 snaps into groove 70 and abuts one face of flange 62. Where insert 28 is provided, end portion 46 of connector 26 is inserted and received within insert 28 with beveled edge 60 entering insert 28 first followed by the constant diameter portion of end portion 46 to create an interference fit between connector 26 and insert 28. The inventive method may continue with step 110 of inserting end portion 42 of connector 26 into one end of tuning cable 24. As end portion 42 is inserted, tuning cable rides over the end form 54 until the end of tuning cable 24 abuts one side of flange 62 of intermediate portion 50 of connector 26. Tuning cable 24 then is supported on end portion 42 in a cantilevered fashion and is inhibited from removal from end portion 42 by end form 54. Although steps 108, 110 are illustrated in FIG. 4 as occurring sequentially, it should be understood that steps 108, 110 could alternatively occur in reverse order or even simultaneously. The inventive method may further include the step 112 of providing a crimp collar 30 disposed about fluid conduit 22 and defining an annular recess 72 and the step 114 of inserting a hose 32 over tuning cable 24 such that the end of hose 32 is received within annular recess 72. The method may further include the step 116 of deforming collar 30 inwardly to couple hose 32 to fluid conduit 22. Step 116 may be achieved by using any of a variety of conventional tools and/or methods known in the industry for deforming collar 30. In particular, deformation may be achieve by applying external pressure to the exterior of crimp collar 30.

A fluid assembly and method of assembly in accordance with the present invention has significant advantages relative to conventional devices and methods used to couple fluid components. In particular, the fluid assembly and method of assembly provide an improved fluid seal between while providing a more efficient connection of the tuning cable and fluid conduit.

While the invention has been shown and described with reference to one ore more particular embodiments thereof, it will be understood by those of skill in the art that various changes and modifications can be made without departing from the spirit and scope of the invention.

I claim:

1. A connector for coupling a fluid conduit and a tuning cable within a fluid assembly, said connector comprising:
a first end portion defining a first port;
a second end portion defining a second port and having an end form over which said tuning cable is disposed;
an intermediate portion disposed between said first and second end portions, said first and second end portions and said intermediate portion together defining a fluid passageway extending from said first port to said second port, said intermediate portion defining:
a radially outwardly extending flange;
a conically tapered section disposed between said flange and said first end portion, said tapered section having an outer diameter that decreases moving from a first point intermediate said flange and said first end portion to a second point at which said intermediate portion and said first end portion intersect;
a groove between said flange and said first point of said tapered section, said groove configured to receive an inwardly projecting lip of said fluid conduit after radial deflection of said lip upon insertion of said connector in said fluid conduit.

2. The connector of claim 1 wherein said end form comprises at least one radially outwardly projecting barb.

3. The connector of claim 1 wherein said second end portion has a beveled edge.

4. The connector of claim 1 wherein at least a section of said first end portion has a constant diameter.

5. The connector of claim 1 wherein said first end portion is configured to receive a tubular insert disposed within said fluid conduit.

6. The connector of claim 1 wherein said fluid assembly is provided in a power steering assembly.

7. A fluid assembly, comprising:
a fluid conduit defining a fluid passageway and a radially inwardly projecting lip at a first end;
a tuning cable; and,
a connector for coupling said fluid conduit and said tuning cable, said connector comprising:
a first end portion defining a first port
a second end portion defining a second port and having an end form over which said tuning cable is disposed; and
an intermediate portion disposed between said first and second end portions, said first and second end portions and said intermediate portion together defining a fluid passageway extending from said first port to said second port, said intermediate portion defining:
a radially outwardly extending flange;
a conically tapered section disposed between said flange and said first end portion, said tapered section having an outer diameter that decreases moving from a first point intermediate said flange and said first end portion to a second point at which said intermediate portion and said first end portion intersect;
a groove between said flange and said first point of said tapered section, said groove configured to receive said inwardly projecting lip of said fluid conduit after radial deflection of said lip upon insertion of said connector in said fluid conduit.

8. The fluid assembly of claim 7, further comprising a tubular insert disposed within said fluid conduit, said first end portion of said connector extending into said tubular insert.

9. The fluid assembly of claim 8 wherein said first end portion of said connector and said tubular insert are engaged in an interference fit.

10. The fluid assembly of claim 7, further comprising:
a crimp collar disposed about said fluid conduit and defining an annular recess;
a hose extending over said tuning cable and said first end of said fluid conduit; said hose extending into said annular recess and coupled to said fluid conduit by deformation of said collar.

11. The fluid assembly of claim 7 wherein said end form of said connector comprises at least one radially outwardly projecting barb.

12. The fluid assembly of claim 7 wherein said first end portion has a beveled edge.

13. The fluid assembly of claim 7 wherein at least a section of said first end portion has a constant diameter.

14. A method of assembling a fluid assembly, comprising the steps of:
providing a connector, said connector comprising:
a first end portion defining a first port; and
a second end portion defining a second port and having an end form;
an intermediate portion disposed between said first and second end portions, said first and second end portions and said intermediate portion together defining a fluid passageway extending from said first port to said second port, said intermediate portion defining:
a radially outwardly extending flange;
a conically tapered section disposed between said flange and said first end portion, said tapered section having an outer diameter that decreases moving from a first point intermediate said flange and said first end portion to a second point at which said intermediate portion and said first end portion intersect;
a groove between said flange and said first point of said tapered section,
inserting said first end portion of said connector into a first end of a fluid conduit, said first end of said fluid conduit defining a radially inwardly extending lip that deflects outwardly as said tapered section of said intermediate portion of said connector is inserted into said fluid conduit and that is received in said groove of said intermediate portion after passing said first point of said intermediate portion of said connector;
inserting said second end portion of said connector into a first end of a tuning cable such that said tuning cable is disposed over said end form.

15. The method of claim 14, further comprising the step of inserting a tubular insert within said fluid conduit wherein said first end portion is inserted into a first end of said tubular insert during said step of inserting said first end portion of said connector into said first end of said fluid conduit.

16. The method of claim 15 wherein said first end portion of said connector and said tubular insert are engaged in an interference fit.

17. The method of claim 14, further comprising the steps of:
providing a crimp collar disposed about said fluid conduit and defining an annular recess; and,
inserting a hose over said tuning cable, said first end of said hose received within said annular recess; and,
deforming said collar inwardly to couple said hose to said fluid conduit.

18. The method of claim 14 wherein said end form comprises at least one radially outwardly projecting barb.

19. The method of claim 14 wherein said first end portion of said connector has a beveled edge.

20. The method of claim 14 wherein at least a section of said s first end portion has a constant diameter.
